(19) United States
(12) Patent Application Publication
(10) Pub. No.: US 2008/0185032 A1
(43) Pub. Date: Aug. 7, 2008

(54) DISCRETE SECONDARY REFLECTOR FOR SOLID CONCENTRATOR

(76) Inventor: Robert MacDonald, Sunnyvale, CA (US)

Correspondence Address: BUCKLEY, MASCHOFF & TALWALKAR LLC, 50 LOCUST AVENUE, NEW CANAAN, CT, 06840, US

(21) Appl. No.: 11/762,852

(22) Filed: Jun. 14, 2007

Related U.S. Application Data
(60) Provisional application No. 60/899,150, filed on Feb. 2, 2007.

(51) Int. Cl. H02N 6/00

(52) U.S. Cl. 136/246

(57) ABSTRACT

A system may provide an element including a curved surface and a first reflective material disposed on the curved surface, and a substantially transparent core. The substantially transparent core may include a first surface coupled to the element, a second surface opposite from the first surface, and a second reflective material disposed on the second surface.

Some aspects provide obtaining of an element including a curved surface and a first reflective material disposed on the curved surface, and coupling of the element to a first surface of a substantially transparent core, the core including a second surface opposite from the first surface and a second reflective material disposed on the second surface.

### CROSS-REFERENCE TO RELATED APPLICATIONS

The present application claims priority to U.S. Provisional Patent Application Ser. No. 60/899,150, filed on Feb. 2, 2007 and entitled “Concentrated Photovoltaic Energy Designs”, the contents of which are incorporated herein by reference for all purposes.

### BACKGROUND

1. Field

Some embodiments generally relate to the conversion of solar radiation to electrical energy. More specifically, embodiments may relate to systems to improve the efficiency of manufacture and/or operation of concentrating solar radiation collectors.

2. Brief Description

A concentrating solar radiation collector may convert received solar radiation (i.e., sunlight) into a concentrated beam and direct the concentrated beam onto a photovoltaic (or, solar) cell. The cell, in turn, generates electrical current based on photons of the concentrated beam.

U.S. Patent Application Publication No. 2006/0231133 describes several types of concentrating solar collectors. As generally described therein, solar radiation enters a solid transparent element and strikes reflective material disposed on a convex surface of the element. The radiation is reflected toward reflective material disposed on a smaller and opposite concave surface, and is reflected thereby toward an even smaller area from which a solar cell may receive the radiation. Such operation may allow the concentrator to convert the received solar radiation to electricity using smaller solar cells than would otherwise be required.

The foregoing operation requires the convex surface, the concave surface and the alignment therebetween to satisfy precise geometric tolerances. Formation of such surfaces on opposite sides of an optically-transparent element (e.g., glass) is difficult and expensive. Moreover, the surface at which the solar radiation enters the element is preferably impact-resistant and/or durable due to its foreseeable exposure to outdoor conditions, but materials exhibiting these characteristics are difficult to mold into precise shapes. In addition, coating the concave surface with reflective material can be expensive and inefficient, since the concave surface comprises a small percentage of the total surface at which the solar radiation enters.

What is needed is a concentrating solar collector to provide one or more advantages of solid concentrator designs while addressing one or more of the foregoing and/or other existing fabrication issues.

### SUMMARY

To address at least the foregoing, some aspects provide a method, means and/or process steps to obtain an element comprising a curved surface and a first reflective material disposed on the curved surface, and to couple the element to a first surface of a substantially transparent core comprising a second surface opposite from the first surface, and a second reflective material disposed on the second surface.

In some aspects, coupling the element to the first surface includes depositing an adhesive on the first surface, depositing an interfacial material on the first surface, and placing the element in contact with the adhesive and the interfacial material, wherein an index of refraction of the interfacial material is substantially equal to an index of refraction of the substantially transparent core.

Coupling the element to the first surface of the substantially transparent core may also or alternatively include placing the element within a depression defined by the first surface such that a reflective side of the first reflective material faces a reflective side of the second reflective material. According to some aspects, coupling the element to the first surface of the substantially transparent core comprises placing a substantially flat portion of the element on a substantially flat portion of the first surface such that a reflective side of the first reflective material faces a reflective side of the second reflective material.

Some aspects provide an apparatus including an element comprising a curved surface and a first reflective material disposed on the curved surface, and a substantially transparent core comprising a first surface coupled to the element, a second surface opposite from the first surface, and a second reflective material disposed on the second surface. Further aspects may include an adhesive deposited on the first surface, and an interfacial material deposited on the first surface, wherein an index of refraction of the interfacial material is substantially equal to an index of refraction of the substantially transparent core, and the element is in contact with the adhesive and the interfacial material.

In addition or alternative to the foregoing aspect, the first surface of the substantially transparent core may define a depression, wherein the element is disposed within the depression such that a reflective side of the first reflective material faces a reflective side of the second reflective material. Similarly, a substantially flat portion of the element may be coupled to a substantially flat portion of the first surface such that a reflective side of the first reflective material faces a reflective side of the second reflective material.

The first surface of the substantially transparent core is tempered in some aspects. Moreover, according to some aspects, a coefficient of thermal expansion of the element is substantially equal to a coefficient of thermal expansion of the substantially transparent core.

The claims are not limited to the disclosed embodiments, however, as those in the art can readily adapt the description herein to create other embodiments and applications.

### BRIEF DESCRIPTION OF THE DRAWINGS

The construction and usage of embodiments will become readily apparent from consideration of the following specification as illustrated in the accompanying drawings, in which like reference numerals designate like parts.

FIG. 1 is an exploded view of an apparatus according to some embodiments.

FIG. 2 is a perspective view of an apparatus according to some embodiments.

FIG. 3 is a cross-sectional view of an apparatus according to some embodiments.

FIG. 4 is an exploded view of an apparatus according to some embodiments.

FIG. 5 is a perspective view of an apparatus according to some embodiments.

FIG. 6 is a cross-sectional view of an apparatus according to some embodiments.

FIG. 7 is an exploded view of an apparatus according to some embodiments.

FIG. 8 is a perspective view of an apparatus according to some embodiments.

FIG. 9 is a cross-sectional view of an apparatus according to some embodiments.

FIG. 10 is a flow diagram according to some embodiments.

FIG. 11 is a perspective view of an array of elements prior to deposition of reflective material according to some embodiments.

FIG. 12 is an exploded view of an array of concentrating solar collectors according to some embodiments.

FIG. 13 is a perspective view of an array of concentrating solar collectors according to some embodiments.

### DETAILED DESCRIPTION

The following description is provided to enable any person in the art to make and use the described embodiments and sets forth the best mode contemplated by for carrying out some embodiments. Various modifications, however, will remain readily apparent to those in the art.

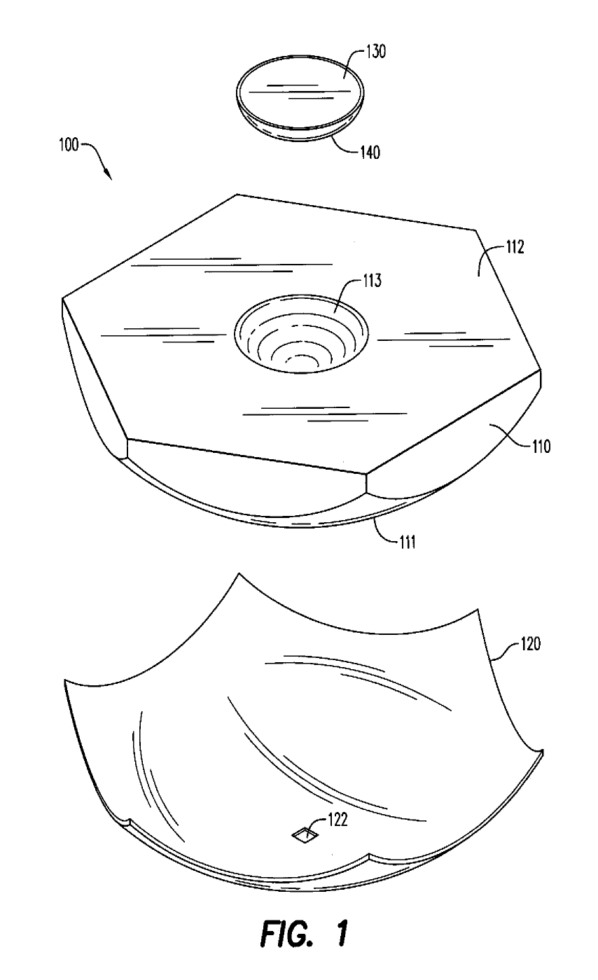

FIG. 1 is an exploded perspective view of apparatus 100 according to some embodiments. Apparatus 100 includes substantially light-transparent core 110, primary mirror 120, and element 130.

Core 110 includes relatively large convex surface 111 and substantially flat surface 112. Core 110 may be composed of any suitable material or combination of materials. According to some embodiments, core 110 is configured to manipulate and/or pass desired wavelengths of light. In some embodiments, core 110 is molded from low-iron glass using known methods. Core 110 may alternatively be formed from a single piece of clear plastic, or separate pieces may be glued or otherwise coupled together to form core 110.

An upper periphery of core 110 of FIG. 1 includes six contiguous facets. This six-sided arrangement may facilitate the formation of large arrays of apparatus 100 in a space-efficient manner. Embodiments are not limited to the illustrated arrangement. For example, some embodiments may include four contiguous facets or no facets.

Primary mirror 120 may be fabricated by sputtering or otherwise depositing a reflective mirror material (e.g., silver (Ag) or aluminum (Al)) directly onto convex surface 111 so that a reflective side of primary mirror 120 faces convex surface 111. Primary mirror 120 defines opening 122 through which concentrated light may exit apparatus 100 and be received by a solar cell (not shown). Apparatus 100 may be used in conjunction with any suitable solar cell arrangement that is or becomes known.

Element 130 comprises a curved surface and reflective material 140 disposed on the curved surface. Element 130 may comprise any suitable material or materials, and may exhibit a coefficient of thermal expansion that is substantially equal to a coefficient of thermal expansion of core 110. Accordingly, element 130 and core 110 may comprise identical materials.

Reflective material 140 may comprise any suitable reflective material, including but not limited to those described above. Unlike primary mirror 120, a reflective side of reflective material 140 faces away from the surface of element 130 on which material 140 is disposed. As shown in the FIG. 1 embodiment, surface 112 of core 110 defines depression 113 roughly corresponding to a shape of reflective material 140. Element 130 may be disposed within depression 113 such that the reflective side of reflective material 140 faces the reflective side of primary mirror 120.

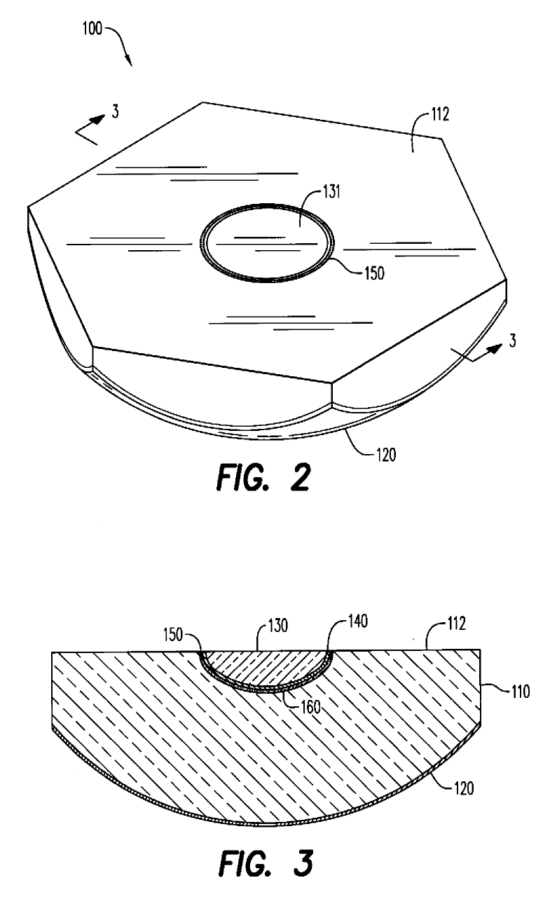

FIG. 2 is a perspective assembled view of apparatus 100. As shown, element 130 is coupled to surface 112 of core 110. More particularly, element 130 is disposed within depression 113 such that the reflective side of reflective material 140 faces the reflective side of primary mirror 120. Although surface 131 of element 130 appears substantially flush with a flat portion of surface 112, embodiments are not limited thereto.

FIG. 3 is a cross-sectional view of a portion of apparatus 100 according to some embodiments. FIG. 3 illustrates one arrangement for coupling element 130 to core 110.

Specifically, adhesive 150 and interfacial material 160 are disposed between element 130 and core 110. Adhesive 150 bonds an outer portion of element 130 to an upper portion of depression 113 of surface 112, but embodiments are not limited thereto. Interfacial material 160 may coat remaining portions of depression 113 as well as portions of element 130 (i.e., reflective material 140) facing the remaining portions of depression 113.

Interfacial material 160 may comprise any material to pass light between core 110 and reflective material 140. For example, interfacial material 160 may comprise a transparent gel having an index of refraction that is substantially equal to an index of refraction of core 110. Such an arrangement may render interfacial material 160 virtually invisible to light passing between core 110 and reflective material 140, thereby reducing losses that would occur if the indices of refraction differed significantly. In this regard, matching the indices of refraction may result in performance at the interface between core 110 and reflective material 140 which is similar to that provided by solid concentrator designs described in U.S. Patent Application Publication No. 2006/0231133.

Some embodiments of apparatus 100 provide an efficient concentrating solar collector. Specifically, geometric tolerances of depression 113 need not be as precise as required by the above-described conventional systems. Rather, element 130 may be separately fabricated to the required tolerances. Moreover, as will be described below, separate fabrication of element 130 may allow for efficient deposition of reflective material 140 thereon.

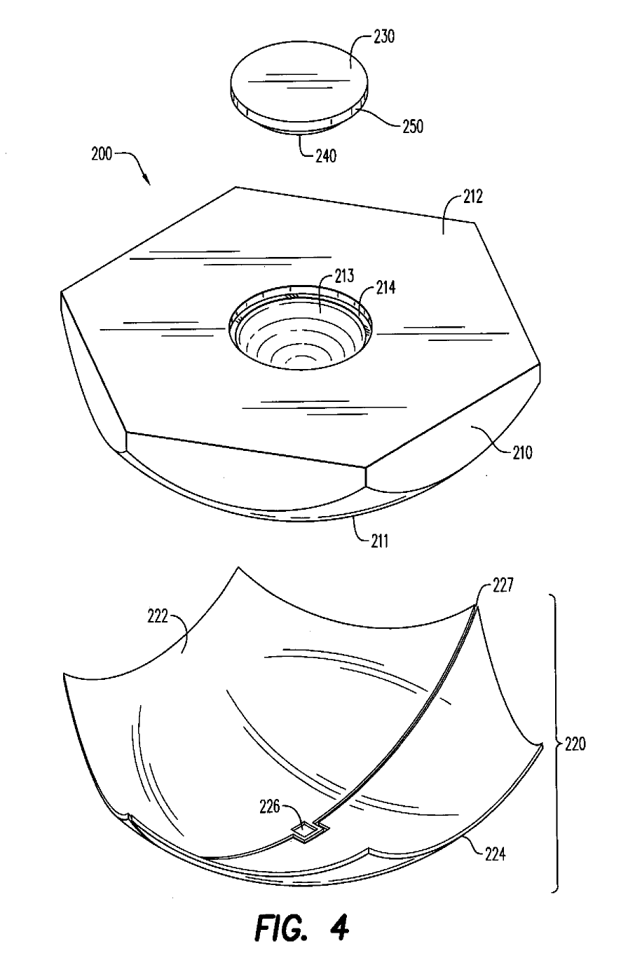

FIG. 4 is an exploded perspective view of apparatus 200 according to some embodiments. Apparatus 200 includes substantially light-transparent core 210, primary mirror 220, and element 230. Core 210, mirror 220 and element 230 may be composed of materials such as those described with respect to respective components 110, 120 and 130 of apparatus 100.

Similar to core 110, core 210 includes relatively large convex surface 211 and substantially flat surface 212. Primary mirror 220 includes conductive portion 222 to be disposed on a first half of convex surface 211, and conductive portion 224 to be disposed on a second half of convex surface 211. Conductive portions 222 and 224 define opening 226 through which concentrated light may exit apparatus 200 and be received by a solar cell. Primary mirror 120 of apparatus 100 may be substituted with primary mirror 220 and/or any other primary mirror illustrated and/or described herein. Alternatively, primary mirror 220 of apparatus 200 may be substituted with primary mirror 120 and/or any other primary mirror illustrated and/or described herein.

Gap 227 is defined between conductive portions 222 and 224 to facilitate electrical isolation thereof. Accordingly, conductive portions 222 and 224 of primary mirror 220 may create a conductive path for electrical current generated by the solar cell. Conductive portions 922 and 924 may also, as described in above-mentioned U.S. patent application Ser. No. 11/110,611, electrically link photovoltaic cells of adjacent collectors in a concentrating solar collector array.

Surface 212 defines depression 213, which in turn includes lip 214 as illustrated. Lip 214 may represent an abrupt change in the width of depression 213, and the width may remain constant from lip 214 to surface 212 as illustrated. Element 230 comprises a curved surface and reflective material 240 disposed on the curved surface. Element 230 also includes structure 250 corresponding to the shape of depression 213 at lip 214.

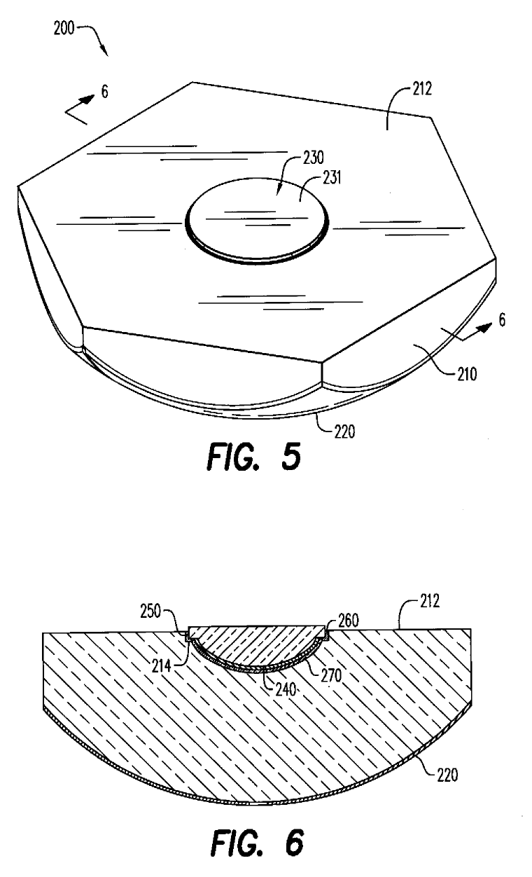

FIG. 5 is a perspective assembled view of apparatus 200. As shown, element 230 is coupled to surface 212 of core 210. Element 230 is disposed within depression 213 such that the reflective side of reflective material 240 faces the reflective side of primary mirror 220. Surface 231 of element 230 rises above a flat portion of surface 212, but embodiments are not limited thereto.

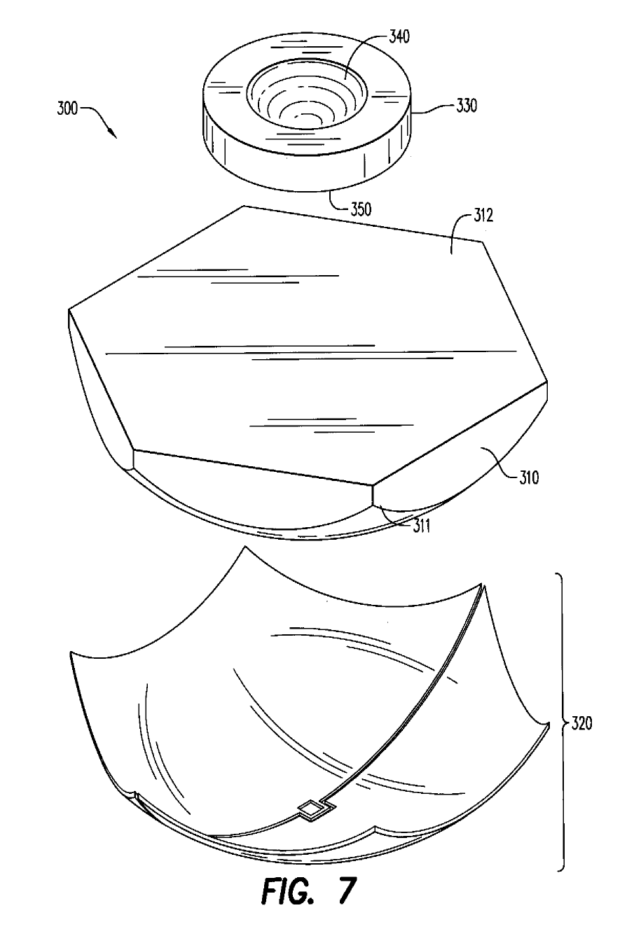

As shown in FIG. 6, structure 250 of element 230 is placed on lip 214. Adhesive 260 bonds a portion of structure 250 at least to lip 214 of depression 213. In the illustrated embodiment, interfacial material 270 coats remaining portions of depression 213 and portions of element 230 facing the remaining portions of depression 213. Interfacial material 270 may comprise any suitable material, including but not limited to those described with respect to interfacial material 160.

Structure 250 and lip 214 may facilitate proper rotational alignment of element 230 within depression 213. Any suitable corresponding structures may be used for lip 214 and structure 215; embodiments are not limited to those illustrated. Moreover, as described with respect to apparatus 100, geometric tolerances of depression 213 need not be as precise as required by the above-described conventional systems and element 230 may be more easily fabricated to the required tolerances with reflective material 240 disposed thereon.

FIG. 7 is an exploded perspective view of apparatus 300 according to some embodiments. Apparatus 300 includes substantially light-transparent core 310, primary mirror 320, and element 330. Core 310, mirror 320 and element 330 may be composed of materials such as those described with respect to respective components 110, 120 and 130 of apparatus 100 and/or respective components 210, 220 and 230 of apparatus 200.

A reflective surface of primary mirror 320 is to be coupled to surface 311 of core 310. Primary mirror 320 is similar to primary mirror 220 of apparatus 200, but embodiments are not limited thereto. Primary mirror 320 may be substituted with primary mirror 120 of apparatus 100 and/or any other suitable primary mirror.

Element 330 includes a curved surface and reflective material 340 disposed thereon. Element 330 also includes a substantially flat portion 350 to be coupled to a substantially flat portion of surface 312. A reflective side of reflective material 340 faces the curved surface of element 340. Accordingly, when assembled, the reflective side faces a reflective side of primary mirror 320.

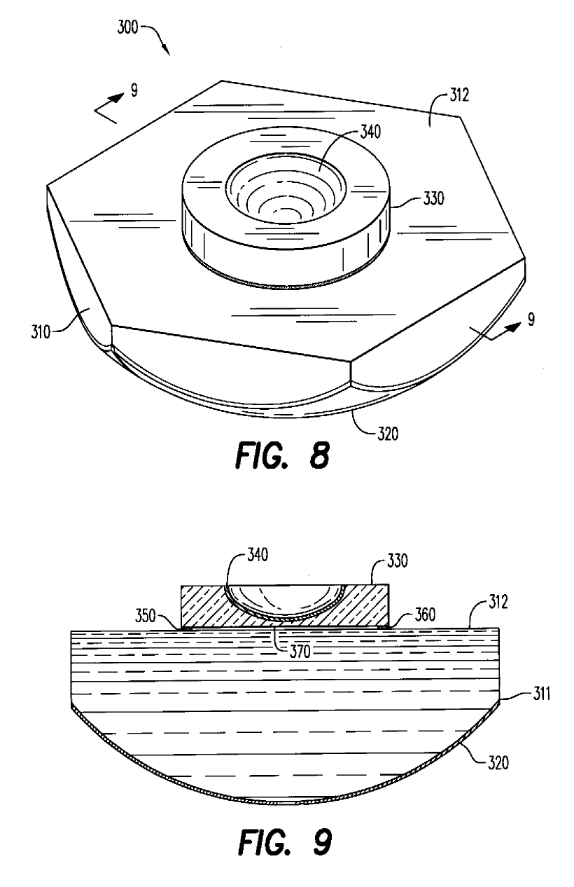

FIG. 8 is a perspective view of apparatus 300 in assembled form. Element 330 is coupled to substantially flat surface 312 of core 310. Some embodiments may include a protective cover on element 330 to protect material 340 from the elements.

Apparatus 300 may be efficiently manufactured because no curved surface is required to be molded on surface 312. Instead, according to some embodiments, surface 312 and may be composed of hard and/or durable material. The material may be tempered or otherwise hardened according to some embodiments. Such hardening may increase the durability of apparatus 300 in operation.

FIG. 9 illustrates embodiments in which the strength of core 320 gradually increases from surface 311 to surface 312. Such embodiments may provide improved operational lifetime while also allowing for accurate molding of surface 311. The change in strength need not be gradual as shown in FIG. 9.

Adhesive 360 bonds a portion of surface 350 to surface 312. Adhesive 360 may be placed on an outer portion of surface 350 or at any other suitable locations. Interfacial material 370 is disposed between surface 350 and surface 312 and may comprise any materials as described above.

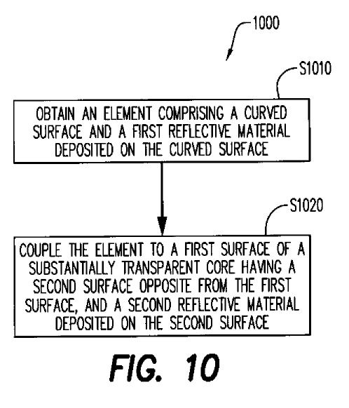

FIG. 10 is a flow diagram of process 1000 according to some embodiments. Process 1000 may be performed by any combination of machine, hardware, software and manual means. Process 1000 may be performed by any one or more entities.

Process 1000 begins at S1010, at which an element is obtained. The element includes a curved surface and a first reflective material deposited on the curved surface. Examples of such an element according to some embodiments include elements 130, 230 and 330 described above.

The element may simply be purchased and received from a seller at S1010. According to some embodiments, the element is fabricated at S1010. For example, the element may be molded from low-iron glass at S1010 using known methods. Separate pieces may be glued or otherwise coupled together to form the element. Next, a reflective material is deposited on the element.

The reflective material may be intended to create one or more mirrored surfaces. The reflective material may be deposited such that a reflective side faces away from the curved surface of the element (e.g., element 130 and element 230), or toward the curved surface of the element (e.g., element 330). Any suitable reflective material may be used, taking into account factors such as but not limited to the wavelengths of light to be reflected, bonding of the reflective material to the optical element, and cost. The reflective material may be deposited by sputtering, evaporation, liquid deposition, etc.

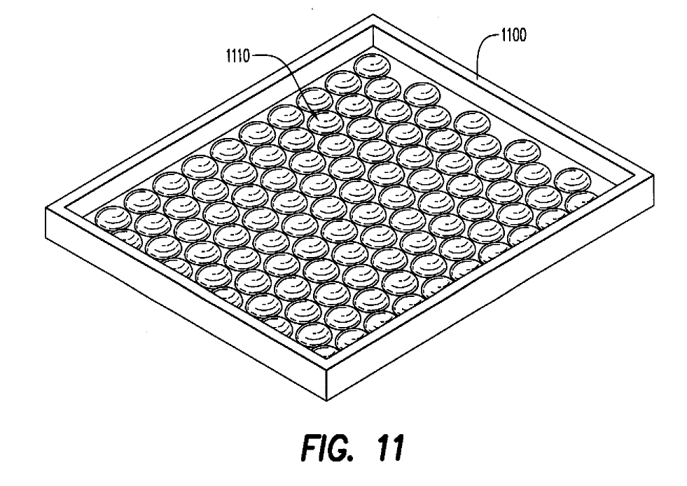

FIG. 11 is a perspective view of tray 1100 and elements 1110 according to some embodiments. Elements 1110 may comprise glass that is shaped as described with respect to element 130 of apparatus 100. Elements 1110 and tray 1100 may be placed in a vacuum chamber and reflective material may be simultaneously deposited on each of elements 1110 in some embodiments of S1010. Some embodiments therefore provide efficient fabrication of elements 1110.

At S1020, the element obtained at S1010 is coupled to a first surface of a substantially-transparent core. The core includes a second surface opposite from the first surface and a second reflective material deposited on the second surface. The core may in some embodiments be similar to cores 110, 210 and 310 of apparatuses 100, 200 and 300. The second reflective material may therefore comprise any suitable ones of primary mirrors 120, 220 or 320, but embodiments are not limited thereto. Generally, the element, core, and surfaces of process 1000 may exhibit any shapes suitable to achieve a desired degree and region of light concentration.

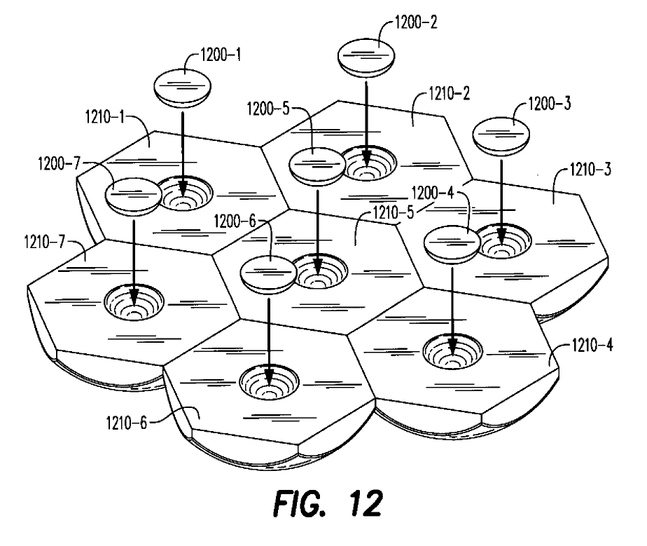

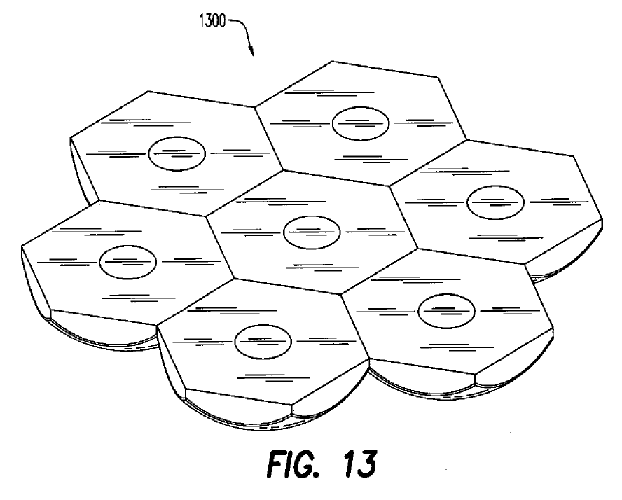

FIG. 12 illustrates coupling of elements 1200-1 through 1200-7 to cores 1210-1 through 1210-7, and FIG. 13 provides a perspective view of tile 1300 after such coupling. Cores 1210-1 through 1210-7 are arranged in an integrated honeycomb pattern. Each of cores 1210-1 through 1210-7 is substantially identical to core 110 and each of elements 1200-1 through 1200-7 is substantially identical to element 130, but again embodiments are not limited thereto.

Tile 1300 and each of apparatuses 100, 200 and 300 may generally operate in accordance with the description of aforementioned U.S. Patent Application Publication No. 2006/0231133. With reference to apparatus 100, solar rays enter surface 112 and are reflected by primary mirror 120 disposed on convex surface 111. The rays are reflected toward reflective material 140 of element 130, and are thereafter reflected toward opening 122. The reflected rays may then pass through opening 122 and be received by a solar cell.

The solar cell therefore receives a substantial portion of the photon energy received at surface 112 and generates electrical current in response to the received photon energy. The electrical current may be passed to external circuitry (and/or to similar serially-connected apparatuses) through primary mirror 120.

The several embodiments described herein are solely for the purpose of illustration. Embodiments may include any currently or hereafter-known versions of the elements described herein. Therefore, persons in the art will recognize from this description that other embodiments may be practiced with various modifications and alterations.

What is claimed is:

1. An apparatus comprising:
an element comprising a curved surface and a first reflective material disposed on the curved surface; and
a substantially transparent core comprising a first surface coupled to the element, a second surface opposite from the first surface, and a second reflective material disposed on the second surface.

2. An apparatus according to claim 1, further comprising
an adhesive deposited on the first surface; and
an interfacial material deposited on the first surface, an index of refraction of the interfacial material being substantially equal to an index of refraction of the substantially transparent core,
wherein the element is in contact with the adhesive and the interfacial material.

3. An apparatus according to claim 2, wherein the first surface of the substantially transparent core defines a depression, and
wherein the element is disposed within the depression such that a reflective side of the first reflective material faces a reflective side of the second reflective material.

4. An apparatus according to claim 2, wherein a substantially flat portion of the element is coupled to a substantially flat portion of the first surface such that a reflective side of the first reflective material faces a reflective side of the second reflective material.

5. An apparatus according to claim 1, wherein the first surface of the substantially transparent core defines a depression, and
wherein the element is disposed within the depression such that a reflective side of the first reflective material faces a reflective side of the second reflective material.

6. An apparatus according to claim 5, wherein the first surface defines a lip within the depression, and
wherein a portion of the element is placed on the lip.

7. An apparatus according to claim 1, wherein a substantially flat portion of the element is coupled to a substantially flat portion of the first surface such that a reflective side of the first reflective material faces a reflective side of the second reflective material.

8. An apparatus according to claim 7, wherein the first surface of the substantially transparent core is tempered.

9. An apparatus according to claim 1, wherein a coefficient of thermal expansion of the element is substantially equal to a coefficient of thermal expansion of the substantially transparent core.

10. An apparatus according to claim 1, wherein the apparatus is to receive solar radiation at the first surface, to concentrate the received solar radiation, and to generate electrical current based on the concentrated radiation.

11. A method comprising:
obtaining an element comprising a curved surface and a first reflective material disposed on the curved surface; and
coupling the element to a first surface of a substantially transparent core comprising a second surface opposite from the first surface, and a second reflective material disposed on the second surface.

12. A method according to claim 11, wherein coupling the element to the first surface of the substantially transparent core comprises:
depositing an adhesive on the first surface;
depositing an interfacial material on the first surface; and
placing the element in contact with the adhesive and the interfacial material,
wherein an index of refraction of the interfacial material is substantially equal to an index of refraction of the substantially transparent core.

13. A method according to claim 12, wherein coupling the element to the first surface of the substantially transparent core comprises:
placing the element within a depression defined by the first surface such that a reflective side of the first reflective material faces a reflective side of the second reflective material.

14. A method according to claim 12, wherein coupling the element to the first surface of the substantially transparent core comprises:
placing a substantially flat portion of the element on a substantially flat portion of the first surface such that a reflective side of the first reflective material faces a reflective side of the second reflective material.

15. A method according to claim 11, further comprising:
placing the first surface of the substantially transparent core in contact with a third surface of a second substantially transparent core; and
depositing the second reflective material on the second surface and a third reflective material on a fourth surface of the second substantially transparent core opposite from the third surface substantially simultaneously.

16. A method according to claim 11, wherein coupling the element to the first surface of the substantially transparent core comprises:
placing the element within a depression defined by the first surface such that a reflective side of the first reflective material faces a reflective side of the second reflective material.

17. A method according to claim 16, wherein the first surface defines a lip within the depression, and
wherein a portion of the element is placed on the lip.

18. A method according to claim 11, wherein coupling the element to the first surface of the substantially transparent core comprises:
placing a substantially flat portion of the element on a substantially flat portion of the first surface such that a reflective side of the first reflective material faces a reflective side of the second reflective material.

19. A method according to claim 18, further comprising:
tempering the first surface of the substantially transparent core.

20. A method according to claim 11, further comprising:
receiving solar radiation at the first surface;
concentrating the received solar radiation; and
generating electrical current based on the concentrated radiation.
